(19) United States
(12) Patent Application Publication
(10) Pub. No.: US 2023/0140970 A1
(43) Pub. Date: May 11, 2023

(54) METHODS, TERMINAL DEVICE AND BASE STATION FOR RANDOM ACCESS PROCEDURE

(71) Applicant: Telefonaktiebolaget LM Ericsson (publ), Stockholm (SE)

(72) Inventors: Zhipeng LIN, Nanjing (CN); Yufei BLANKENSHIP, Kildeer, IL (US); Robert Mark HARRISON, Grapevine, TX (US)

(73) Assignee: Telefonaktiebolaget LM Ericsson (publ), Stockholm (SE)

(21) Appl. No.: 17/310,939

(22) PCT Filed: Mar. 25, 2020
(86) PCT No.: PCT/CN2020/081173

§ 371 Date: Aug. 31, 2021

(30) Foreign Application Priority Data
Mar. 27, 2019 (WO) PCT/CN2019/079945

(51) Int. Cl. H04W 74/08; H04L 1/00; H04L 1/08

(52) U.S. Cl. CPC H04W 74/0841; H04L 1/0003; H04L 1/08

(57) ABSTRACT

Methods, a terminal device and a base station for random access procedure. According to an embodiment, the terminal device determines a request message for random access. The request message comprises a preamble and one or more physical uplink shared channels (PUSCHs). The terminal device transmits the request message.

### CROSS-REFERENCE TO RELATED APPLICATIONS

This application is a National stage of International Application No. PCT/CN2020/081173, filed Mar. 25, 2020, which claims priority to International Application No. PCT/CN2019/079945, filed Mar. 27, 2019, which are hereby incorporated by reference.

### TECHNICAL FIELD

Embodiments of the disclosure generally relate to wireless communication, and, more particularly, to methods, a terminal device and a base station for random access procedure.

### BACKGROUND

This section introduces aspects that may facilitate better understanding of the present disclosure. Accordingly, the statements of this section are to be read in this light and are not to be understood as admissions about what is in the prior art or what is not in the prior art.

In new radio (NR) system, a four-step approach as shown in FIG. 1 may be used for random access procedure. In this approach, the user equipment (UE) detects a synchronization signal (SS) and decodes the broadcasted system information (which may be distributed over multiple physical channels, e.g. physical broadcast channel (PBCH) and physical downlink shared channel (PDSCH)) to acquire random access transmission parameters, followed by transmitting a physical random access channel (PRACH) preamble (message 1) in the uplink. The next generation node B (gNB) detects the message 1 and replies with a random access response (RAR, message 2). The UE then transmits a UE identification (message 3) on physical uplink shared channel (PUSCH). Then the gNB transmits a contention resolution message (CRM, message 4) to the UE to solve conflict caused when multiple UEs transmit the same PRACH preamble.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide another solution for random access procedure.

According to a first aspect of the disclosure, there is provided a method implemented at a terminal device. The method may comprise determining a request message for random access. The request message may comprise a preamble and one or more PUSCHs. The method may further comprise transmitting the request message.

In an embodiment of the disclosure, a fixed modulation and coding scheme (MCS) table may be preconfigured to be used for determining the request message.

In an embodiment of the disclosure, PI/2 binary phase shift keying (BPSK) may be preconfigured to be disabled in the terminal device.

In an embodiment of the disclosure, a number of the one or more PUSCHs may be more than one, and the more than one PUSCHs may be multiple repetitions of a PUSCH.

In an embodiment of the disclosure, the multiple repetitions of the PUSCH may be divided into one or more PUSCH transmission sets.

In an embodiment of the disclosure, the random access may be initiated due to a failure of previous random access. A number of the multiple repetitions of the PUSCH for the access may be no less than that for the previous random access.

In an embodiment of the disclosure, each repetition of the PUSCH may be associated with the preamble.

In an embodiment of the disclosure, a number of the multiple repetitions of the PUSCH may be from at least one of: radio resource control (RRC) signalling; preconfiguration in the terminal device; and determination based on at least one of: preamble information, demodulation reference signal (DMRS) information, use case information, and frequency band information.

In an embodiment of the disclosure, the preamble and respective repetitions of the PUSCH may be time division multiplexed and/or frequency division multiplexed.

In an embodiment of the disclosure, each repetition of the PUSCH may use a corresponding redundant version (RV) in a RV sequence.

In an embodiment of the disclosure, the RV sequence may be from at least one of: RRC signalling, and preconfiguration in the terminal device.

In an embodiment of the disclosure, a number of repetitions of the PUSCH in each PUSCH transmission set for the random access may be no less than that for the previous random access. Alternatively or additionally, a number of the one or more PUSCH transmission sets for the random access may be no less than that for the previous random access.

In an embodiment of the disclosure, the request message may be determined such that a size of a transport block (TB) carried in a PUSCH is scaled relative to a reference size of the TB carried in the PUSCH, with a scaling factor.

In an embodiment of the disclosure, the reference size of the TB may be determined based on a first product of: a number of resource elements (REs) usable for carrying the TB, a modulation order and a target code rate for the TB. The size of the TB may be determined based on a second product of the scaling factor and the first product.

In an embodiment of the disclosure, the scaling factor may be from at least one of: RRC signalling; preconfiguration in the terminal device; selection from a preconfigured set of values based on a channel quality estimate; and determination based on at least one of: preamble information, DMRS information, use case information, and frequency band information.

In an embodiment of the disclosure, the request message may be determined based on an MCS table having a lower spectrum efficiency than a reference MCS table.

In an embodiment of the disclosure, the MCS table may be a table obtained by adding into, the reference MCS table, one or more rows having lower spectrum efficiencies.

In an embodiment of the disclosure, the MCS table may be obtained by removing, from the reference MCS table, one or more rows having higher spectrum efficiencies.

In an embodiment of the disclosure, the reference MCS table may be a quadrature amplitude modulation (QAM) 64 low spectrum efficieny (QAM64LowSE) MCS table with transform precoder enabled or a QAM64LowSE MCS table with transform precoder disabled.

In an embodiment of the disclosure, the MCS table may be a table defined instead of or separately from the reference MCS table.

In an embodiment of the disclosure, which MCS table is to be used for determining the request message may be indicated via RRC signalling. Alternatively, which MCS table is to be used for determining the request message may be determined based on at least one of: preamble information, DMRS information, use case information, and frequency band information.

In an embodiment of the disclosure, whether PI/2 BPSK is to be enabled for determining the request message may be indicated via RRC signalling. Alternatively, PI/2 BPSK may be preconfigured to be enabled in the terminal device.

In an embodiment of the disclosure, the method may further comprise providing user data and forwarding the user data to a host computer via the transmission to a base station.

According to a second aspect of the disclosure, there is provided a method implemented in a communication system including a host computer, a base station and a terminal device. The method may comprise, at the host computer, receiving user data transmitted to the base station from the terminal device. The terminal device may determine a request message for random access. The request message may comprise a preamble and one or more PUSCHs. The terminal device may transmit the request message.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to a third aspect of the disclosure, there is provided a method implemented at a base station. The method may comprise receiving a request message for random access. The request message may comprise a preamble and one or more PUSCHs. The method may further comprise obtaining the one or more PUSCHs from the request message.

In an embodiment of the disclosure, a fixed MCS table may be preconfigured to be used for obtaining the one or more PUSCHs in the base station.

In an embodiment of the disclosure, PI/2 BPSK may be preconfigured to be disabled for the request message in the base station.

In an embodiment of the disclosure, a number of the one or more PUSCHs may be more than one, and the more than one PUSCHs may be multiple repetitions of a PUSCH.

In an embodiment of the disclosure, the multiple repetitions of the PUSCH may be divided into one or more PUSCH transmission sets.

In an embodiment of the disclosure, the random access may be initiated due to a failure of previous random access. A number of the multiple repetitions of the PUSCH for the random access may be no less than that for the previous random access.

In an embodiment of the disclosure, each repetition of the PUSCH may be associated with the preamble.

In an embodiment of the disclosure, a number of the multiple repetitions of the PUSCH may be one of: transmitted in RRC signalling; preconfigured in the base station; and determined based on at least one of: preamble information, DMRS information, use case information, and frequency band information.

In an embodiment of the disclosure, the preamble and respective repetitions of the PUSCH may be time division multiplexed and/or frequency division multiplexed.

In an embodiment of the disclosure, each repetition of the PUSCH may use a corresponding RV in a RV sequence.

In an embodiment of the disclosure, the RV sequence may be transmitted in RRC signalling, or preconfigured in the base station.

In an embodiment of the disclosure, a number of repetitions of the PUSCH in each PUSCH transmission set for the random access may be no less than that for the previous random access. Alternatively or additionally, a number of the one or more PUSCH transmission sets for the random access may be no less than that for the previous random access.

In an embodiment of the disclosure, a size of a TB carried in a PUSCH may be scaled relative to a reference size of the TB carried in the PUSCH, with a scaling factor.

In an embodiment of the disclosure, the reference size of the TB may be determined based on a first product of: a number of REs usable for carrying the TB, a modulation order and a target code rate for the TB. The size of the TB may be determined based on a second product of the scaling factor and the first product.

In an embodiment of the disclosure, the scaling factor may be one of: transmitted in RRC signalling; preconfigured in the base station; blindly detected from a preconfigured set of values; and determined based on at least one of: preamble information, DMRS information, use case information, and frequency band information.

In an embodiment of the disclosure, the one or more PUSCHs may be obtained based on an MCS table having a lower spectrum efficiency than a reference MCS table.

In an embodiment of the disclosure, the MCS table may be a table obtained by adding into, the reference MCS table, one or more rows having lower spectrum efficiencies.

In an embodiment of the disclosure, the MCS table may be obtained by removing, from the reference MCS table, one or more rows having higher spectrum efficiencies.

In an embodiment of the disclosure, the reference MCS table may be a QAM64LowSE MCS table with transform precoder enabled or a QAM64LowSE MCS table with transform precoder disabled.

In an embodiment of the disclosure, the MCS table may be a table defined instead of or separately from the reference MCS table.

In an embodiment of the disclosure, which MCS table is to be used for obtaining the one or more PUSCHs may be transmitted in RRC signalling. Alternatively, which MCS table is to be used for obtaining the one or more PUSCHs may be determined based on at least one of: preamble information, DMRS information, use case information, and frequency band information.

In an embodiment of the disclosure, whether PI/2 BPSK is to be enabled for the request message may be transmitted in RRC signalling. Alternatively, PI/2 BPSK may be preconfigured to be enabled for the request message in the base station.

According to a fourth aspect of the disclosure, there is provided a method implemented in a communication system including a host computer, a base station and a terminal device. The method may comprise, at the host computer, receiving, from the base station, user data originating from a transmission which the base station has received from the terminal device. The base station may receive a request message for random access. The request message may comprise a preamble and one or more PUSCHs. The base station may obtain the one or more PUSCHs from the request message.

In an embodiment of the disclosure, the method may further comprise, at the base station, receiving the user data from the terminal device.

In an embodiment of the disclosure, the method may further comprise, at the base station, initiating a transmission of the received user data to the host computer.

According to a fifth aspect of the disclosure, there is provided a terminal device. The terminal device may comprise at least one processor and at least one memory. The at least one memory may contain instructions executable by the at least one processor, whereby the terminal device may be operative to determine a request message for random access. The request message may comprise a preamble and one or more PUSCHs. The terminal device may be further operative to transmit the request message.

In an embodiment of the disclosure, the terminal device may be operative to perform the method according to the above first aspect.

According to a sixth aspect of the disclosure, there is provided a communication system including a host computer. The host computer may comprise a communication interface configured to receive user data originating from a transmission from a terminal device to a base station. The terminal device may comprise a radio interface and processing circuitry. The processing circuitry of the terminal device may be configured to determine a request message for random access. The request message may comprise a preamble and one or more PUSCHs. The processing circuitry of the terminal device may be further configured to transmit the request message.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to a seventh aspect of the disclosure, there is provided a base station. The base station may comprise at least one processor and at least one memory. The at least one memory may contain instructions executable by the at least one processor, whereby the base station may be operative to receive a request message for random access. The request message may comprise a preamble and one or more PUSCHs. The base station may be further operative to obtain the one or more PUSCHs from the request message.

In an embodiment of the disclosure, the base station may be operative to perform the method according to the above third aspect.

According to an eighth aspect of the disclosure, there is provided a communication system including a host computer. The host computer may comprise a communication interface configured to receive user data originating from a transmission from a terminal device to a base station. The base station may comprise a radio interface and processing circuitry. The base station’s processing circuitry may be configured to receive a request message for random access. The request message may comprise a preamble and one or more PUSCHs. The base station’s processing circuitry may be further configured to obtain the one or more PUSCHs from the request message.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

According to a ninth aspect of the disclosure, there is provided a computer program product. The computer program product may comprise instructions which when executed by at least one processor, cause the at least one processor to perform the method according to any of the above first and third aspects.

According to a tenth aspect of the disclosure, there is provided a computer readable storage medium. The computer readable storage medium may comprise instructions which when executed by at least one processor, cause the at least one processor to perform the method according to any of the above first and third aspects.

According to an eleventh aspect of the disclosure, there is provided a terminal device. The terminal device may comprise a determination module for determining a request message for random access. The request message may comprise a preamble and one or more PUSCHs. The terminal device may further comprise a transmission module for transmitting the request message.

According to a twelfth aspect of the disclosure, there is provided a base station. The base station may comprise a reception module for receiving a request message for random access. The request message may comprise a preamble and one or more PUSCHs. The base station may further comprise an obtaining module for obtaining the one or more PUSCHs from the request message.

According to a thirteenth aspect of the disclosure, there is provided a method implemented in a communication system including a base station and at least one terminal device. The method may comprise, at the at least one terminal device, determining a request message for random access. The request message may comprise a preamble and one or more PUSCHs. The method may further comprise, at the at least one terminal device, transmitting the request message. The method may further comprise, at the base station, receiving the request message for random access. The request message may comprise the preamble and the one or more PUSCHs. The method may further comprise, at the base station, obtaining the one or more PUSCHs from the request message.

According to a fourteenth aspect of the disclosure, there is provided a communication system comprising at least one terminal device and a base station. The at least one terminal device may be configured to determine a request message for random access and transmit the request message. The request message may comprise a preamble and one or more PUSCHs. The base station may be configured to receive the request message for random access and obtain the one or more PUSCHs from the request message. The request message may comprise the preamble and the one or more PUSCHs.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a four-step random access procedure in NR;

FIG. 2 is a diagram illustrating a two-step random access procedure in NR;

FIG. 3 is a diagram illustrating the second embodiment of the disclosure;

FIG. 4 is a diagram illustrating the third embodiment of the disclosure;

FIGS. 5-6 are diagrams for explaining the second and third embodiments;

FIG. 7 is a flowchart illustrating a method implemented at a terminal device according to an embodiment of the disclosure;

FIG. 8 is a flowchart illustrating a method implemented at a base station according to an embodiment of the disclosure;

FIG. 9 is a block diagram showing an apparatus suitable for use in practicing some embodiments of the disclosure;

FIG. 10 is a block diagram showing a terminal device according to an embodiment of the disclosure;

FIG. 11 is a block diagram showing a base station according to an embodiment of the disclosure;

FIG. 12 is a diagram showing a telecommunication network connected via an intermediate network to a host computer in accordance with some embodiments;

FIG. 13 is a diagram showing a host computer communicating via a base station with a user equipment in accordance with some embodiments;

FIG. 14 is a flowchart illustrating a method implemented in a communication system in accordance with some embodiments;

FIG. 15 is a flowchart illustrating a method implemented in a communication system in accordance with some embodiments;

FIG. 16 is a flowchart illustrating a method implemented in a communication system in accordance with some embodiments; and

FIG. 17 is a flowchart illustrating a method implemented in a communication system in accordance with some embodiments.

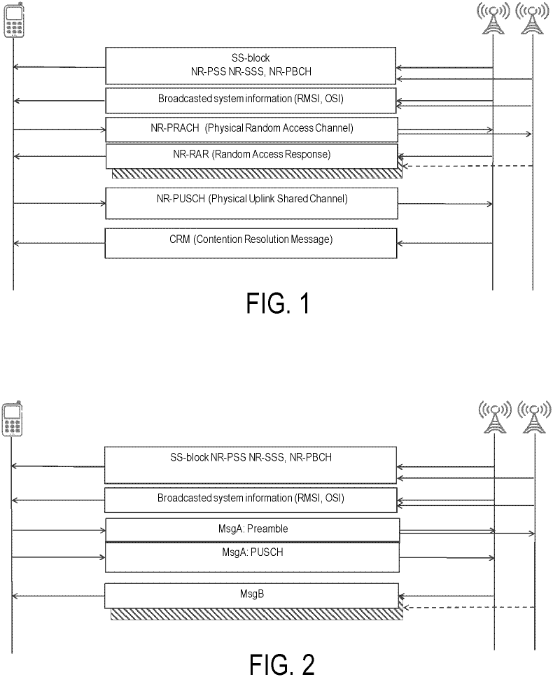

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

In the four-step random access procedure, the UE transmits PUSCH (message 3) after receiving a timing advance command in the RAR and after adjusting the timing of the PUSCH transmission, allowing PUSCH to be received at the gNB with a timing accuracy within the cyclic prefix (CP). Without this timing advance functionality, a very large CP would be needed in order to be able to demodulate and detect PUSCH, unless the system is applied in a cell with very small distance between the UE and the gNB. Since NR will also support larger cells, there is a need for providing a timing advance to the UE and thus the four-step approach is needed for random access procedure.

The random access response carried in message 2 includes 4 bits for time domain resource allocation and 4 bits identifying the MCS to be used for message 3. The time domain resource allocation bits are used with Table 6.1.2.1.1-2 or Table 6.1.2.1.1-3 in 3rd generation partnership project (3GPP) technical specification (TS) 38.214 V15.4.0 to identify which PUSCH mapping type (A or B) to use, which slot carries the PUSCH via the parameter K₂, the starting symbol S relative to the start of the slot, the length L of the PUSCH transmission in orthogonal frequency division multiplexing (OFDM) symbols. The 4 bits identifying the MCS determine the parameters I_{MCS} (MCS index) and Qₘ (modulation order) given by the lowest 16 entries of the MCS tables for PUSCH, described below.

To determine the transport block size for PUSCH carrying message 3, the UE determines the number (N’_{RE}) of resource elements (REs) allocated for PUSCH within a physical resource block (PRB) by

$${N}^{'} {}_{R E} = {N}_{S C}^{R B} ⋅ {N}_{s y m b}^{s h} - {N}_{D M R S}^{P R B} - {N}_{o h}^{P R B} ,$$

as described in section 6.1.4.2 of 3GPP TS 38.214 V15.4.0. An intermediate number of PUSCH information bits (N_{info}) is obtained by N_{info} = N_{RE}·R·Qₘ·υ, as described in step 2) of section 5.1.3.2 of 3GPP TS 38.214 V15.4.0. As defined in section 3.2 of 3GPP TS 38.211, the parameter υ is the number of layers used for transmission of a TB. The actual transport block size used is then given by either step 3) or step 4) of section 5.1.3.2 of 3GPP TS 38.214 V15.4.0 according to if N_{info} ≤ 3824.

In TS 38.214 V15.4.0, two MCS tables with highest modulation order of 64-QAM are defined for PDSCH transmission, see Table 5.1.3.1-1 and Table 5.1.3.1-3 from TS 38.214 V15.4.0. The Table 5.1.3.1-1 is the “qam64” MCS table for OFDM, while the Table 5.1.3.1-3 is the “qam64LowSE” table for OFDM. These tables are also used for PUSCH when transform precoding is disabled. For message 3 (Msg3) PUSCH transmission, the UE shall consider the transform precoding either ‘enabled’ or ‘disabled’ according to the higher layer configured parameter msg3-transformPrecoder.

In TS 38.214 V15.4.0, two MCS tables with highest modulation order of 64-QAM are defined for PUSCH transmission with transform precoding, see Table 6.1.4.1-1 and Table 6.1.4.1-2 from TS 38.214 V15.4.0. The Table 6.1.4.1-1 is the “qam64” MCS table for discrete Fourier transform (DFT)-spread-OFDM (DFT-s-OFDM), while Table 6.1.4.1-2 is the “qam64LowSE” MCS table for DFT-s-OFDM. For Table 6.1.4.1-1 and Table 6.1.4.1-2, if higher layer parameter tp-pi2BPSK is configured, q = 1 otherwise q=2, where tp-pi2BPSK is defined as below.

tp-pi2BPSK ENUMERATED {enabled} OPTIONAL, -- Need S
tp-pi2BPSK
Enables pi/2-BPSK modulation with transform precoding if the field is present and disables it
otherwise.

As illustrated in FIG. 2, in a 2-step random access procedure, the step of detecting synchronization signal block (SSB) and system information is the same as in the 4-step approach, but the initial access is completed in only two steps in order to minimize the number of channel accesses. This is important for e.g. operation in unlicensed frequency bands where listen before talk must be performed before transmission. At the first step, the UE sends a request message for random access (denoted as message A) including random access preamble together with higher layer data such as RRC connection request possibly with some small additional payload on PUSCH. At the second step, the gNB sends a response message (denoted as message B) including UE identifier assignment, timing advance information, and contention resolution message, etc.

When introducing the 2-step random access procedure, the PUSCH in message A (denoted as msgA) can be transmitted immediately after an associated random access channel (RACH) preamble. So compared to normal PUSCH, the PUSCH in msgA may collide with other PUSCHs when two UEs select the same PUSCH resource. Furthermore, msgA PUSCHs may not be well time aligned at the gNB, since the UE may not have an accurate timing advance. The preamble part of the msgA usually has better performance than the PUSCH part since there is no data transmission in the preamble part. Therefore, it would be desirable to provide methods on PUSCH enhancement to improve the msgA detection success rate in the 2-step random access procedure.

The present disclosure proposes an improved solution for 2-step random access procedure. The solution may be applied to a wireless communication system including a terminal device and a base station. The terminal device can communicate through a radio access communication link with the base station. The base station can provide radio access communication links to terminal devices that are within its communication service cell. The base station may be, for example, a gNB in NR. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the improved solution for random access procedure. As the first embodiment, transport block size (TBS) scaling may be performed for PUSCH in msgA by using a TBS scaling factor S. The TBS scaling factor S is a positive value and S<=1. To apply the TBS scaling, the existing PUSCH TBS determination procedure may be modified to achieve a lower code rate for MsgA PUSCH, such that the actual spectral efficiency used for the TB transmission is lower than the nominal spectral efficiency (modulation order Qₘ × code rate R) from the MCS table. By lowering the code rate of PUSCH, an improved decoding performance can be expected.

As an exemplary example, for the PUSCH carrying MsgA, the TBS determination may follow the procedure for determining TBS for PUSCH carrying message 3 as described above, except that the calculation of the intermediate number of PUSCH information bits (N_{info}) in step 2 in TS 38.214 Section “5.1.3.2 Transport block size determination” is modified to include TBS scaling according to N_{info} = S·N_{RE}·R·Qₘ·ν, rather than N_{info} = N_{RE}·R·Qₘ·ν, and the MCS information and time domain resource allocation may be signaled via RRC signaling rather than using downlink control information (DCI).

The code rate R and modulation order Qₘ may be provided by the MCS index I_{MCS} together with the MCS table. For instance, the values of the code rate R and the modulation order Qₘ may be determined by rows of an MCS table containing the smallest code rates R. The variable N_{RE} represents the number of resource elements (REs) usable for transmitting the TB, and may be provided by the time and frequency domain configurations. For the time domain configuration, time domain resource allocation bits that indicate the starting symbol S and the PUSCH duration L may be provided via (e.g. broadcast or UE specific) RRC signaling. For frequency domain configuration, the number of PRBs allocated for the MsgA TB transmission may be provided via (e.g. broadcast or UE specific) RRC signaling. For instance, the time domain resource allocation parameters may be identified using Table 6.1.2.1.1-2 or Table 6.1.2.1.1-3 of 3GPP TS 38.214.

For N_{RE} calculation, two variables

$${N}_{D M R S}^{P R B}$$

and

$${N}_{o h}^{P R B}$$

may also be needed.

$${N}_{D M R S}^{P R B}$$

is the number of REs for DMRS per PRB in the allocated duration for PUSCH. Thus

$${N}_{D M R S}^{P R B}$$

may be determined by DMRS configuration of the PUSCH transmission, including the number of DMRS code division multiplexing (CDM) group and DMRS ports.

$${N}_{o h}^{P R B}$$

is the number of REs per PRB for other overhead. For simplicity,

$${N}_{o h}^{P R B}$$

may be set as a fixed value, e.g.,

$${N}_{o h}^{P R B} = 0.$$

For instance, one or more possible TBS scaling factors may be defined similar to the TBS scaling for PDSCH for paging and RAR. As an exemplary example, the scaling factor table of 4 entries as shown in Table 1 below may be used. Alternatively, a scaling factor table of 2 entries as shown in Table 2 below may be used.

TABLE 1

Scaling factor for TBS determination for msgA PUSCH

| TB scaling field | Scaling factor S |
|---|---|
| 00 | 1 |
| 01 | 0.5 |
| 10 | 0.25 |
| 11 | 0.125 |

TABLE 2

Scaling factor for TBS determination for msgA PUSCH

| TB scaling field | Scaling factor S |
|---|---|
| 0 | 0.5 |
| 1 | 0.25 |

The TBS scaling factor S used may be determined via one of the options below. As the first option, the value of S may be signaled in RRC signaling (e.g. system information or RRC dedicated signaling). In this way, the semi-static value of S may be sent from a gNB to a UE, and the UE may apply the signaled value S. Note that a default value of S may be configured in the UE if the signalling is optional. As the second option, a gNB may configure a set of possible values for S, e.g. 2 possible values as shown in Table 2. The UE may select one value from the set and apply it for a given MsgA transmission. For instance, the UE may select the scaling factor S according to an estimate of channel quality such as reference signal receiving power (RSRP). If the channel quality is above or below a predetermined threshold, a larger or a smaller value of S may be used, respectively. At the gNB receiver, which value of S the UE selects is not known and the receiver may blindly detect which value of S is actually used. For example, the gNB may try the two possible values, S=0.5 or 0.25, in Table 2. The value S that results in successful detection of the PUSCH may be deemed as the value actually applied by the UE. Successful detection of the PUSCH may be achieved when the decoding of the carried transport block successfully passes the cyclic redundancy check (CRC) check.

As the third option, the value of S may be implicitly determined by other known parameters. For example, other known parameters may be used to select one value from the set of 4 possible S values shown in Table 1. Possible parameters that may be used for the derivation of value S may include, but not limited to, PRACH preamble information (e.g. format and/or ID, PRACH occasion), DMRS information, use case information, frequency band information (e.g. licensed or unlicensed, frequency range 1 (FR1) or FR2). As the fourth option, S may take a fixed value. For example, S=0.25. It should be noted that in the first embodiment, since TBS scaling is applied, a higher modulation type may also be used when a low coding rate is expected.

As the second embodiment, PUSCH repetition may be used for one PUSCH transmission. For example, the PUSCH may be configured with K repetitions for MsgA, where K is an integer and K>=1. Thus, one PUSCH transmission set may be defined to be composed of K repetitions of a TB that carries MsgA higher layer data. In a MsgA, one PRACH preamble may be followed by the PUSCH transmission set. The time and frequency locations of the PUSCH transmission set may be related to an index that identifies the PRACH preamble. In other words, each of the K repetitions may be associated with a PRACH preamble that is transmitted prior to the repetitions. Each of the K repetitions may be transmitted in a predetermined location in time and frequency and correspond to an index that identifies the PRACH preamble. Note that the term “repetition” is used here in such a way that 1 repetition refers to a TB itself and 2 repetitions refer to a TB itself and one repetition of the TB.

In the time domain, the UE may transmit each of the K repetitions of the set at different instants in time. The K repetitions may occupy K consecutive, available uplink transmission units, starting at a predefined instance relative to the end of the PRACH preamble. For example, in a time division duplexing (TDD) system, the symbols unavailable for PUSCH transmission may be excluded, which include downlink (DL) symbols, gap symbols, flexible symbols, symbols for sounding reference signal (SRS).

The predetermined locations in time may be signaled to the UE as one or more of: a periodicity in units of symbols between when the repetitions can begin, an offset indicating when a repetition can start relative to a system frame number, an indication of a starting symbol, and a length of the PUSCH transmission relative to a symbol identified by the periodicity and offset. As an exemplary example, the predetermined location in time may be indicated according to one or more of the following parameters: periodicity, timeDomainOffset, and timeDomainAllocation in the information element (IE) ConfiguredGrantConfig in 3GPP TS 38.331 V15.4.0.

In the frequency domain, the K repetitions may or may not use frequency hopping. If frequency hopping is not applied, the K repetitions may occupy the same set of PRBs. If frequency hopping is applied, the K repetitions may occupy different set of PRBs, in order to achieve frequency diversity.

The predetermined location in frequency may be signaled for a repetition as: a starting virtual resource block and a length in terms of contiguously allocated resource blocks. As an exemplary example, the predetermined location in frequency may be identified using the parameter frequencyDomainAllocation in the IE ConfiguredGrantConfig in 3GPP TS 38.331 V15.4.0. In a case that each repetition may be configured to occupy a different location in frequency, each repetition may be configured with a different value of frequencyDomainAllocation.

The parameter K may be provided to the UE using one of the following options. As the first option, the value of K may be signaled via RRC signaling. The RRC signaling may be carried in broadcast system information or dedicated signaling. In this way, the semi-static value of K may be sent from a gNB to a UE, and the UE may apply the signaled value K in a set of PUSCH transmissions. Note that a default value of K may be configured in the UE if the signalling is optional. As the second option, K may take a fixed value. For example, K=2. As the third option, K may be associated to other parameters, e.g. PRACH preamble information (e.g. format and/or ID, PRACH occasion), DMRS information, use case information, frequency band information (e.g. licensed or unlicensed, FR1 or FR2).

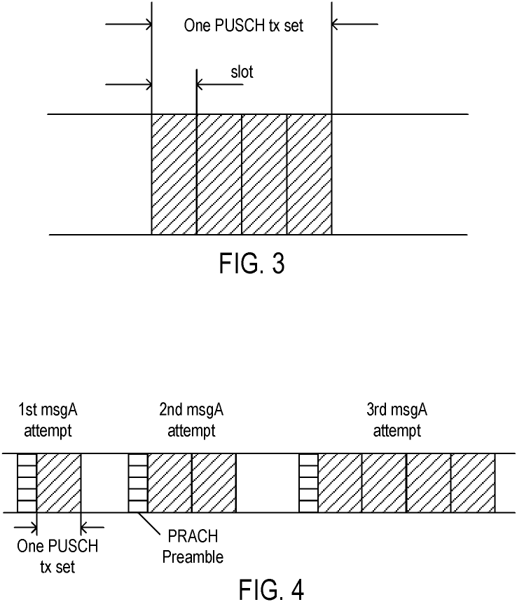

Optionally, the unit of repetition may be uniform, where the unit may be slot or mini-slot. For example, as shown in FIG. 3, one PUSCH transmission set is composed of 4 repetitions and the repetition unit is a slot. If the unit is slot and K>1, then for the TB of MsgA, the UE may repeat the TB across the K consecutive, designated, slots. Two alternatives are possible for PUSCH location in each slot. In the first alternative, the UE may apply the same symbol allocation in each slot. That is, PUSCH may occupy the same {start, end} symbol location in each designated slot. In the second alternative, the UE may be allowed to use PUSCH of different {start, end} symbol allocation in each designated slot.

If the unit is mini-slot and K>1, then the UE may repeat the TB across the K consecutive, designated, mini-slots. If the K repetitions of mini-slot require crossing slot boundary, then the UE may use one of the following alternatives. In the first alternative, the UE may terminate the PUSCH transmission at the mini-slot repetition which will cause slot boundary crossing. Depending on the mini-slot duration and value of K, the UE may not be able to complete the K repetitions. In the second alternative, the UE may complete K repetitions, regardless of slot boundary crossing or not. It should be noted that the unit of repetition may be non-uniform instead. For example, the 1^{st}, 2^{nd}, 3^{rd} repetitions of the MsgA TB may use a 7-symbol mini-slot, a slot (which contains 14 symbols), and a 4-symbol mini-slot, respectively.

In the above discussion, K designated slot (and similarly for designated mini-slot) may refer to one of the following:
1) K slots according to absolute slot numbering. In this alternative, for a TDD system, some slots may not be available for PUSCH transmission if a slot (or some symbols in a slot) is marked for downlink transmission. Such unavailable slots are skipped, leading to potentially fewer than K slots for actual PUSCH repetition.
2) K slots that are available for PUSCH transmission. In this alternative, for a TDD system, due to slots unavailable for PUSCH transmission, the PUSCH transmission may span more than K slots in terms of absolute slot numbering.
3) K slots that are defined according to a periodicity and a timeDomainOffset.

Optionally, between the K repetitions of a PUSCH transmission, a redundant version (RV) sequence may be defined so that each of the K PUSCH repetitions may use a different RV. As a non-limiting example, for the nth transmission occasion among K repetitions (n=1, 2, ..., K), it may be associated with (mod(n-1,4)+1)^{th} value in the provided RV sequence.

The RV sequence may be provided to the UE by one of the following options. As the first option, the RV sequence may be RRC configured. The RRC signalling may be system information or RRC dedicated signaling. As the second option, the RV sequence may be fixed. Examples of length-4 RV sequences may include {0,0,0,0}, {0,2,3,1}, {0,3,0,3}, or the like.

As the third embodiment, repeated PUSCH transmissions may be used for progressive msgA attempt. For example, when a UE makes msgA attempts, a msgA attempt may fail and the UE needs to try again. After sending the j-th msgA attempt, the UE may wait to see if the gNB sends MsgB. If msgB is not received within a predefined time interval, the UE may consider the j-th msgA failed, and may make a (j+1)-th msgA attempt. To improve the success probability in the (j+1)-th attempt, the UE may increasingly repeat the PUSCH transmission in progressive msgA attempts.

As an example, the PUSCH transmission set may be repeated, where a PUSCH transmission set may be composed of K repetitions of a given TB. For example, in the j-th msgA attempt, the UE may repeat the PUSCH transmission Lⱼ times. In the (j+1)-th msgA attempt, the UE may repeat the PUSCH transmission Lⱼ₊₁ times, where Lⱼ₊₁> Lⱼ>=1. Consider that one PUSCH transmission is composed of K repetitions of the MsgA TB, the j-th and (j+1)-th msgA attempt uses K^{∗}Lⱼ and K^{∗}Lⱼ₊₁ repetitions of the TB, respectively. For instance, as illustrated in FIG. 4, the 1^{st}/2^{nd}/3^{rd} MsgA attempt uses 1/2/4 PUSCH transmission set of the given MsgA TB.

As another example, the length of the PUSCH transmission set is increased after each failed MsgA attempt. For example, in the j-th msgA attempt, the PUSCH transmission set may be composed of Kⱼ repetitions of the MsgA TB, and the UE may repeat the MsgA TB Kⱼ times. In the (j+1)-th msgA attempt, the PUSCH transmission set may be composed of Kⱼ₊₁ repetitions of the MsgA TB, and the UE may repeat the MsgA TB Kⱼ₊₁ times, where Kⱼ₊₁>Kⱼ>=1. The values of Kⱼ and Kⱼ₊₁ may be determined by the parameters used by the j-th and (j+1)-th msgA transmission, respectively and/or the number j, and/or a step size for increasing the number of repetitions.

In the above second and third embodiments, the repeated PUSCH transmissions and/or the PUSCH repetitions in one transmission may be on a consecutive or a predetermined set of PUSCH timing frequency resources configured for msgA PUSCH transmissions in 2-step random access. The PRACH occasions and PUSCH occasions for one msgA transmission may be in a time division multiplexed and/or frequency division multiplexed manner.

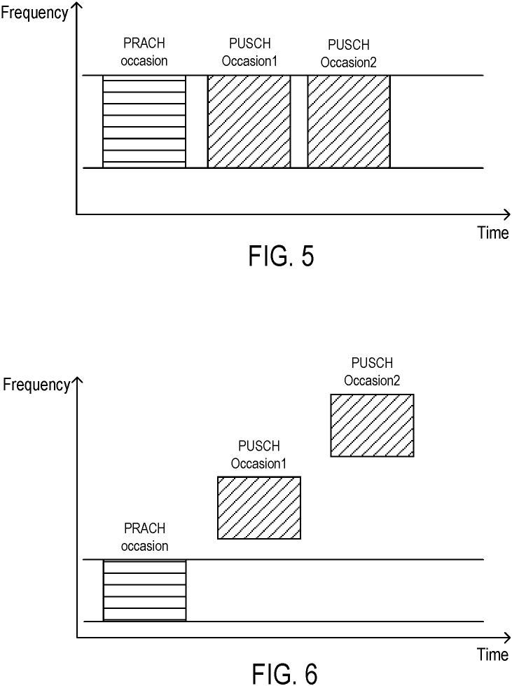

For example, FIG. 5 shows a PRACH occasion multiplexed with 2 PUSCH occasions in time division multiplexing (TDM) manner. As shown, one msgA transmission may comprise one preamble transmission in a PRACH occasion, one PUSCH transmission of a transport block carried on PUSCH occasion #1 in a first time interval and a second PUSCH transmission of the transport block carried on PUSCH occasion #2 in a second time interval. In this example, the PRACH and both PUSCH transmissions occupy the same frequency domain resources.

FIG. 6 shows a variant of the example illustrated in FIG. 5. As shown, the PRACH and two PUSCH transmissions are still transmitted in separate time intervals, but the PUSCH occasions may also occupy different frequency resources from the PRACH and from each other. Transmitting the PUSCH transport block in different frequency resources may improve performance by providing diversity gain in multipath fading channels or by enhancing robustness to interference where interference varies in frequency.

As the fourth embodiment, to improve PUSCH performance, the low spectral efficiency 64QAM MCS tables (“qam64LowSE” tables, e.g., TS38.214 V15.4.0, Table 5.1.3.1-3 and Table 6.1.4.1-2) may be used. The qam64LowSE MCS table contains lower MCS values with lower target coding rate than the normal, qam64, MCS tables (e.g., TS38.214 V15.4.0, Table 5.1.3.1-1 and Table 6.1.4.1-1). Specifically, MCS index I_{MCS} in the range of 0-5 can provide lower spectral efficiency entries than those in the normal 64QAM MCS table 1 (“qam64” table, e.g., TS38.214 V15.4.0, Table 6.1.4.1-1: MCS index table 1).

As an exemplary example, more rows of MCS values may be added to the “qam64LowSE” MCS tables with even lower spectral efficiency. Optionally, some rows of MCS values with high spectral efficiencies may be removed from the “qam64LowSE” MCS tables. This may create a new “qam64LowSE2” MCS table for OFDM, and a new “qam64LowSE2” MCS table for DFT-s-OFDM. The new “qam64LowSE2” MCS table for OFDM is shown in Table 3 below. As shown, two rows with lower spectral efficiency are added with I_{MCS}=0 and 1, while two rows with the highest spectral efficiency in qam64 MCS table of OFDM (e.g., TS38.214 V15.4.0, Table 5.1.3.1-3: MCS index table 3 for PDSCH) are removed. Similar qam64LowSE2″ MCS table for DFT-s-OFDM may also be introduced.

TABLE 3

qam64LowSE2 MCS index table for PUSCH with transform precoding disabled

| MCS Index I_{MCS} | Modulation Order Qₘ | Target code Rate R x [1024] | Spectral efficiency |
|---|---|---|---|
| 0 | 2 | 15 | 0.0293 |
| 1 | 2 | 20 | 0.0391 |
| 2 | 2 | 30 | 0.0586 |
| 3 | 2 | 40 | 0.0781 |
| 4 | 2 | 50 | 0.0977 |
| 5 | 2 | 64 | 0.1250 |
| 6 | 2 | 78 | 0.1523 |
| 7 | 2 | 99 | 0.1934 |
| 8 | 2 | 120 | 0.2344 |
| 9 | 2 | 157 | 0.3066 |
| 10 | 2 | 193 | 0.3770 |
| 11 | 2 | 251 | 0.4902 |
| 12 | 2 | 308 | 0.6016 |
| 13 | 2 | 379 | 0.7402 |
| 14 | 2 | 449 | 0.8770 |
| 15 | 2 | 526 | 1.0273 |
| 16 | 2 | 602 | 1.1758 |
| 17 | 4 | 340 | 1.3281 |
| 18 | 4 | 378 | 1.4766 |
| 19 | 4 | 434 | 1.6953 |
| 20 | 4 | 490 | 1.9141 |
| 21 | 4 | 553 | 2.1602 |
| 22 | 4 | 616 | 2.4063 |
| 23 | 6 | 438 | 2.5664 |
| 24 | 6 | 466 | 2.7305 |
| 25 | 6 | 517 | 3.0293 |
| 26 | 6 | 567 | 3.3223 |
| 27 | 6 | 616 | 3.6094 |
| 28 | 6 | 666 | 3.9023 |
| 29 | 2 | reserved | |
| 30 | 4 | reserved | |
| 31 | 6 | reserved | |

Optionally, some RRC signalling may be signalled to determine which table will be used for msgA PUSCH in 2-step random access (RA). For example, the following fields may be added to (e.g. broadcast RRC or UE-specific) RRC signalling to select the MCS table.

| | |
|---|---|
| mcs-Table-msgA | ENUMERATED {qam64, qam64LowSE, qam64LowSE2 |
| } | |
| OPTIONAL, -- Need S | |
| mcs-TableTransformPrecoder-msgA | ENUMERATED {qam64, qam64LowSE, qam64LowSE2 |
| } | |
| OPTIONAL, -- Need S | |

Similarly, the corresponding configuration about whether to use the transform precoder or not may be also signalled with (e.g. broadcast or UE-specific) RRC signalling, as shown below.

| | |
|---|---|
| transformPrecoderMsgA | ENUMERATED {enabled, disabled} |
| OPTIONAL, -- Need S | |

Alternatively, a fixed table may be applied for 2-step RA. For example, it may be predefined that the qam64LowSE MCS table should be used. Furthermore, whether or not to use transform precoding may be predefined for MsgA, together with the MCS table to use. For example, transform precoding may be always disabled for PUSCH MsgA.

Alternatively, which table is to be used may be determined by other factors, e.g. PRACH preamble information (PRACH format and/or preamble ID, PRACH occasion), DMRS information, use case information, frequency band information (e.g. licensed or unlicensed, FR1 or FR2).

Optionally, a new MCS table may be separately defined from the existing tables for msgA PUSCH transmissions. For example, the 8-entry Table 4 shown below may be used for MsgA PUSCH with transform precoding disabled. No reserved entries are included in Table 4 if MsgA PUSCH has no retransmissions.

TABLE 4

qam64LowSE2 MCS index table for PUSCH with transform precoding disabled

| MCS Index I_{MCS} | Modulation Order Qₘ | Target code Rate R x [1024] | Spectral efficiency |
|---|---|---|---|
| 0 | 2 | 15 | 0.0293 |
| 1 | 2 | 20 | 0.0391 |
| 2 | 2 | 30 | 0.0586 |
| 3 | 2 | 40 | 0.0781 |
| 4 | 2 | 50 | 0.0977 |
| 5 | 2 | 64 | 0.1250 |
| 6 | 2 | 78 | 0.1523 |
| 7 | 2 | 99 | 0.1934 |

If MsgA PUSCH has retransmissions, some reserved rows may be included for each modulation order, as shown in Table 5 below.

TABLE 5

qam64LowSE2 MCS index table for PUSCH with transform precoding disabled

| MCS Index I_{MCS} | Modulation Order Qₘ | Target code Rate R x [1024] | Spectral efficiency |
|---|---|---|---|
| 0 | 2 | 15 | 0.0293 |
| 1 | 2 | 20 | 0.0391 |
| 2 | 2 | 30 | 0.0586 |
| 3 | 2 | 40 | 0.0781 |
| 4 | 2 | 50 | 0.0977 |
| 5 | 2 | 64 | 0.1250 |
| 6 | 2 | 78 | 0.1523 |
| 7 | 2 | reserved | |

Optionally, whether PI/2 BPSK is to be supported for msgA PUSCH when transform precoding is enabled may be considered with below alternatives. As the first alternative, PI/2-BPSK may be always enabled or disabled. As the second alternative, whether PI/2-BPSK is to be enabled may be signaled via RRC signalling. The signalling may be a cell-specific RRC signalling or UE dedicated RRC signalling if possible. As an exemplary example, below parameter tp-pi2BPSK-msgA may be defined in the PUSCH-ConfigCommon IE which is used to configure the cell specific PUSCH parameters.

| | | |
|---|---|---|
| tp-pi2BPSK-msgA | ENUMERATED {enabled} | OPTIONAL, --Need S |
| tp-pi2BPSK-msgA | | |

Enables pi/2-BPSK modulation with transform precoding for msgA if the field is present and disables it otherwise.

As the fifth embodiment, for the first to fourth embodiments described above, the msgA attempt may include the transmission with either “both preamble and PUSCH” or “only PUSCH”.

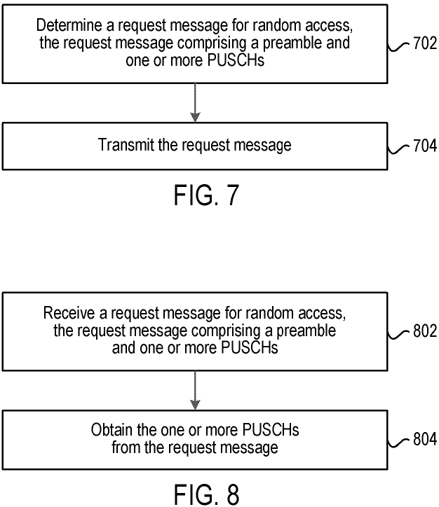

Hereinafter, the solution will be further described with reference to FIGS. 7-17. FIG. 7 is a flowchart illustrating a method implemented at a terminal device according to an embodiment of the disclosure. At block 702, the terminal device determines a request message for random access. The request message comprises a preamble and one or more PUSCHs. At block 704, the terminal device transmits the request message. The random access may be two-step random access and the request message may be message A. For example, the request message may be determined at block 702 with one or more of three options described below. The request message may be transmitted to a base station through an air interface at block 704.

As the first option, a number of the one or more PUSCHs is more than one, and the more than one PUSCHs are multiple repetitions of a PUSCH. In this way, the reliability of PUSCH transmission of the request message can be improved such that the detection/decoding rate of the request message can be improved in two-step random access procedure. For example, the multiple repetitions of the PUSCH may be divided into one or more PUSCH transmission sets. Each PUSCH transmission set may include more than one repetitions of the PUSCH.

As described above in the second and third embodiments, each repetition of the PUSCH may be associated with the preamble. The number of the multiple repetitions of the PUSCH may be obtained from RRC signalling and/or preconfiguration in the terminal device. Alternatively, the number of the multiple repetitions of the PUSCH may be determined based on at least one of: preamble information, DMRS information, use case information, and frequency band information. The preamble and respective repetitions of the PUSCH may be time division multiplexed and/or frequency division multiplexed. Optionally, each repetition of the PUSCH may use a corresponding redundant version (RV) in a RV sequence. The RV sequence may be obtained from RRC signalling and/or preconfiguration in the terminal device.

The first option may be applied to the case of retransmission of the request message. For example, the random access may be initiated due to a failure of previous random access. In this case, the number of the multiple repetitions of the PUSCH for the access may be no less than that for the previous random access. For example, the number of repetitions of the PUSCH in each PUSCH transmission set for the random access may be no less than that for the previous random access. Additionally or alternatively, the number of the one or more PUSCH transmission sets for the random access may be no less than that for the previous random access.

As the second option, the size of a TB carried in a PUSCH is scaled relative to a reference size of the TB carried in the PUSCH, with a scaling factor. The scaling factor may be a positive value smaller than or equal to one. As described above in the first embodiment, the reference size of the TB may be determined based on a first product of: a number of REs usable for carrying the TB, a modulation order and a target code rate for the TB. The size of the TB may be determined based on a second product of the scaling factor and the first product. The scaling factor may be obtained from RRC signalling and/or preconfiguration in the terminal device. Alternatively, the scaling factor may be selected from a preconfigured set of values based on a channel quality estimate. Alternatively, the scaling factor may be determined based on at least one of: preamble information, DMRS information, use case information, and frequency band information.

As the third option, the request message is determined based on a MCS table having a lower spectrum efficiency than a reference MCS table. For example, as described above in the fourth embodiment, the MCS table may be a table obtained by adding into, the reference MCS table, one or more rows having lower spectrum efficiencies. Optionally, the MCS table may be obtained by removing, from the reference MCS table, one or more rows having higher spectrum efficiencies. As an exemplary example, the reference MCS table may be a QAM64LowSE MCS table with transform precoder enabled or a QAM64LowSE MCS table with transform precoder disabled. The MCS table may be a table defined instead of or separately from the reference MCS table.

Optionally, which MCS table is to be used for determining the request message may be indicated via RRC signalling. Alternatively, a fixed MCS table may be preconfigured to be used for determining the request message. Alternatively, which MCS table is to be used for determining the request message may be determined based on at least one of: preamble information, DMRS information, use case information, and frequency band information.

Optionally, whether PI/2 BPSK is to be enabled for determining the request message may be indicated via RRC signalling. Alternatively, PI/2 BPSK may be preconfigured to be enabled or disabled in the terminal device.

FIG. 8 is a flowchart illustrating a method implemented at a base station according to an embodiment of the disclosure. At block 802, the base station receives a request message for random access. The request message comprises a preamble and one or more PUSCHs. At block 804, the base station obtains the one or more PUSCHs from the request message. The random access may be two-step random access and the request message may be message A. The request message may be received from a terminal device through an air interface at block 802. The one or more PUSCHs may be obtained at block 804 with one or more of three options described below. Note that when more than one PUSCHs are included in the request message, some or all of the more than one PUSCHs may be obtained at block 804, as described later.

As the first option, a number of the one or more PUSCHs is more than one, and the more than one PUSCHs are multiple repetitions of a PUSCH. In this way, the detection/decoding rate of the request message can be improved in two-step random access procedure. For example, the multiple repetitions of the PUSCH may be divided into one or more PUSCH transmission sets. Each PUSCH transmission set may include more than one repetitions of the PUSCH.

As described above in the second and third embodiments, each repetition of the PUSCH may be associated with the preamble. The number of the multiple repetitions of the PUSCH may be transmitted to a terminal device in RRC signalling. Alternatively, there is no need for transmitting the RRC signalling and the number of the multiple repetitions of the PUSCH may be preconfigured in both the base station and the terminal device. Alternatively, the number of the multiple repetitions of the PUSCH may be determined by the base station based on at least one of: preamble information, DMRS information, use case information, and frequency band information. The preamble and respective repetitions of the PUSCH may be time division multiplexed and/or frequency division multiplexed. Optionally, each repetition of the PUSCH may use a corresponding RV in a RV sequence. The RV sequence may be transmitted to a terminal device in RRC signalling. Alternatively, there is no need for transmitting the RRC signalling and the RV sequence may be preconfigured in both the base station and the terminal device.

The first option may be applied to the case of receiving retransmission of the request message. For example, the random access may be initiated due to a failure of previous random access. In this case, the number of the multiple repetitions of the PUSCH for the access may be no less than that for the previous random access. For example, the number of repetitions of the PUSCH in each PUSCH transmission set for the random access may be no less than that for the previous random access. Additionally or alternatively, the number of the one or more PUSCH transmission sets for the random access may be no less than that for the previous random access. Correspondingly, the base station may obtain at least part of the multiple repetitions of the PUSCH based on the configuration of the request message described above. For example, if some repetition(s) of the PUSCH can be correctly decoded, the other repetitions of the PUSCH can be omitted.

As the second option, the size of a TB carried in a PUSCH is scaled relative to a reference size of the TB carried in the PUSCH, with a scaling factor. The scaling factor may be a positive value smaller than or equal to one. As described above in the first embodiment, the reference size of the TB may be determined based on a first product of: a number of REs usable for carrying the TB, a modulation order and a target code rate for the TB. The size of the TB may be determined based on a second product of the scaling factor and the first product. The scaling factor may be transmitted to a terminal device in RRC signalling. Alternatively, there is no need for transmitting the RRC signalling and the scaling factor is preconfigured in both the base station and the terminal device. Alternatively, the scaling factor may be blindly detected from a preconfigured set of values. Alternatively, the scaling factor may be determined based on at least one of: preamble information, DMRS information, use case information, and frequency band information. Correspondingly, the base station may obtain the PUSCH from the request message based on the scaling factor.

As the third option, the one or more PUSCHs are obtained based on a MCS table having a lower spectrum efficiency than a reference MCS table. For example, as described above in the fourth embodiment, the MCS table may be a table obtained by adding into, the reference MCS table, one or more rows having lower spectrum efficiencies. Optionally, the MCS table may be obtained by removing, from the reference MCS table, one or more rows having higher spectrum efficiencies. As an exemplary example, the reference MCS table may be a QAM64LowSE MCS table with transform precoder enabled or a QAM64LowSE MCS table with transform precoder disabled. The MCS table may be a table defined instead of or separately from the reference MCS table.

Optionally, which MCS table is to be used for obtaining the one or more PUSCHs may be transmitted to a terminal device in RRC signalling. Alternatively, there is no need for transmitting the RRC signalling and a fixed MCS table may be preconfigured to be used for obtaining the one or more PUSCHs in both the base station and the terminal device. Alternatively, which MCS table is to be used for obtaining the one or more PUSCHs is determined based on at least one of: preamble information, DMRS information, use case information, and frequency band information.

Optionally, whether PI/2 BPSK is to be enabled for obtaining the one or more PUSCHs may be indicated to a terminal device via RRC signalling. Alternatively, there is no need for transmitting the RRC signalling and PI/2 BPSK may be preconfigured to be enabled or disabled in both the base station and the terminal device. It should be noted that two blocks shown in succession in the figures may, in fact, be executed substantially concurrently, or the blocks may sometimes be executed in the reverse order, depending upon the functionality involved.

In an embodiment, the present disclosure also provides a method for determining a number of information bits to be used in a random access transmission. The method may comprise determining a set of parameters including a modulation order Qₘ, a code rate R, and a number of resource elements carrying PUSCH, N_{RE}. The method may further comprise determining an information payload scaling factor S. The method may further comprise calculating an intermediate number of information bits to be used in the random access transmission as N_{info} = S · N_{RE} · R · Qₘ. The method may further comprise quantizing the intermediate number of information bits to form the number of information bits to be used in the random access transmission.

Optionally, the step of determining the information payload scaling factor S may further comprise selecting the value of S from a set of values according to a channel quality estimate. The value of S may be greater for greater channel quality.

In an embodiment, the present disclosure also provides a method for repeating a transport block used in a random access transmission. The method may comprise determining a first number of repetitions of the transport block, K. The method may further comprise determining a location in time and frequency for each of the K repetitions of the transport block. The method may further comprise transmitting a first random access preamble. The method may further comprise transmitting the K repetitions of the transport block, each in its time and frequency location, and each associated with the first random access preamble.

Optionally, the method may further comprise determining a second number of repetitions K2 for repeating the transport block, where K2 is greater than K. The method may further comprise determining a location in time and frequency for each of the K2 repetitions of the transport block. The method may further comprise transmitting a second random access preamble. The method may further comprise transmitting the K2 repetitions of the transport block, each in its time and frequency location, and each associated with the second random access preamble.

Optionally, the preamble and repetitions may be time division multiplexed and a repetition can be in a different set of subcarriers than the preamble. For example, the first random access preamble may be transmitted in a first set of OFDM symbols and in a first set of subcarriers. Each of the K repetitions may be transmitted in a different set of OFDM symbols than the other K repetitions and from the first set of OFDM symbols. At least one of the K repetitions may occupy a second set of subcarriers that is distinct from the first set of subcarriers.

Based on the above description, at least one aspect of the present disclosure provides a method implemented in a communication system including a base station and at least one terminal device. The method may comprise, at the at least one terminal device, determining a request message for random access. The request message may comprise a preamble and one or more PUSCHs. The method may further comprise, at the at least one terminal device, transmitting the request message. The method may further comprise, at the base station, receiving the request message for random access. The request message may comprise the preamble and the one or more PUSCHs. The method may further comprise, at the base station, obtaining the one or more PUSCHs from the request message.

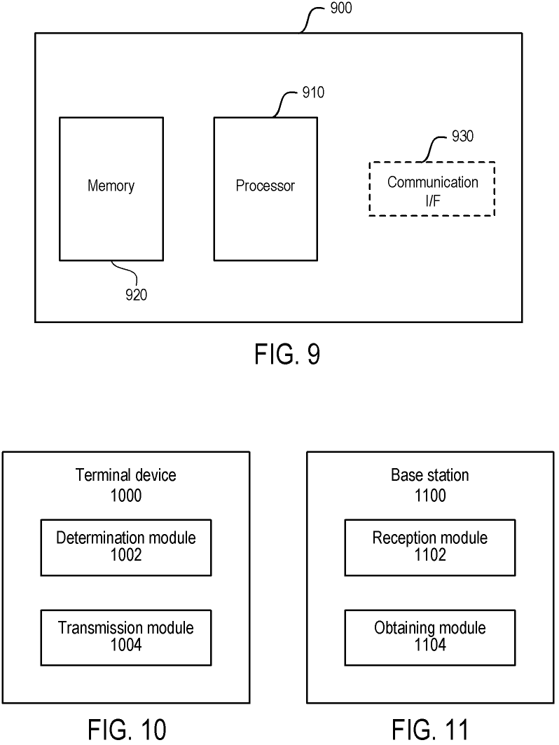

FIG. 9 is a block diagram showing an apparatus suitable for use in practicing some embodiments of the disclosure. For example, any one of the terminal device and the base station described above may be implemented through the apparatus 900. As shown, the apparatus 900 may include a processor 910, a memory 920 that stores a program, and optionally a communication interface 930 for communicating data with other external devices through wired and/or wireless communication.

The program includes program instructions that, when executed by the processor 910, enable the apparatus 900 to operate in accordance with the embodiments of the present disclosure, as discussed above. That is, the embodiments of the present disclosure may be implemented at least in part by computer software executable by the processor 910, or by hardware, or by a combination of software and hardware.

The memory 920 may be of any type suitable to the local technical environment and may be implemented using any suitable data storage technology, such as semiconductor based memory devices, flash memories, magnetic memory devices and systems, optical memory devices and systems, fixed memories and removable memories. The processor 910 may be of any type suitable to the local technical environment, and may include one or more of general purpose computers, special purpose computers, microprocessors, digital signal processors (DSPs) and processors based on multi-core processor architectures, as non-limiting examples.

FIG. 10 is a block diagram showing a terminal device according to an embodiment of the disclosure. As shown, the terminal device 1000 comprises a determination module 1002 and a transmission module 1004. The determination module 1002 may be configured to determine a request message for random access, as described above with respect to block 702. The request message comprises a preamble and one or more PUSCHs. The transmission module 1004 may be configured to transmit the request message, as described above with respect to block 704.

FIG. 11 is a block diagram showing a base station according to an embodiment of the disclosure. As shown, the base station 1100 comprises a reception module 1102 and an obtaining module 1104. The reception module 1102 may be configured to receive a request message for random access, as described above with respect to block 802. The request message comprises a preamble and one or more PUSCHs. The obtaining module 1104 may be configured to obtain the one or more PUSCHs from the request message, as described above with respect to block 804. The modules described above may be implemented by hardware, or software, or a combination of both.

Based on the above description, at least one aspect of the present disclosure provides a communication system comprising at least one terminal device and a base station. The at least one terminal device may be configured to determine a request message for random access and transmit the request message. The request message may comprise a preamble and one or more PUSCHs. The base station may be configured to receive the request message for random access and obtain the one or more PUSCHs from the request message. The request message may comprise the preamble and the one or more PUSCHs.

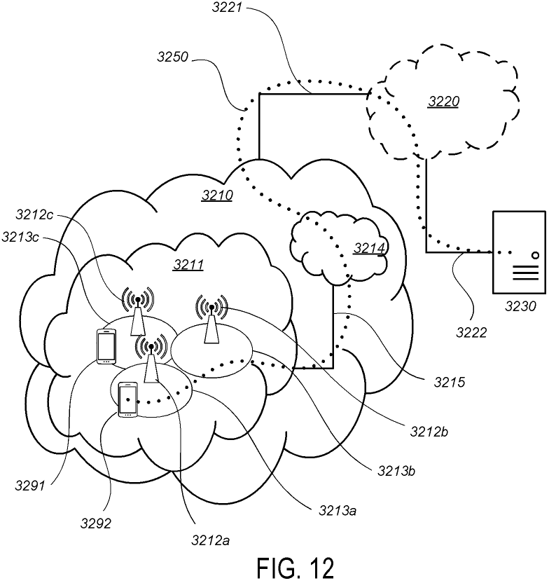

With reference to FIG. 12, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more subnetworks (not shown).

The communication system of FIG. 12 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

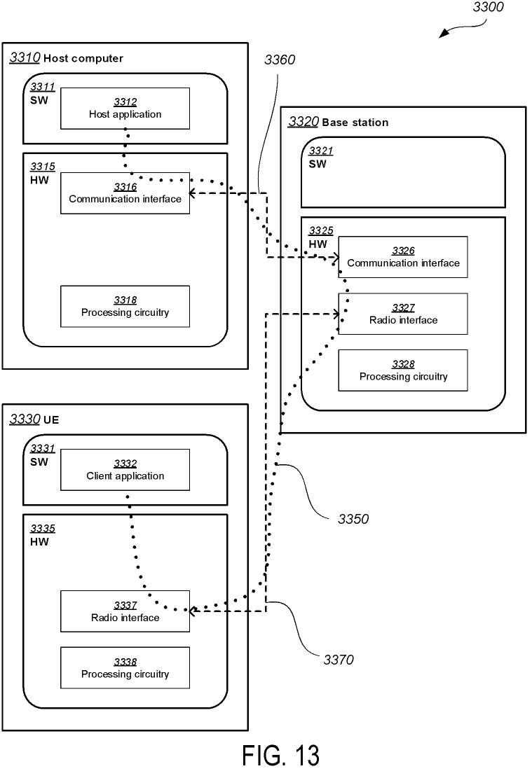

Example implementations, in accordance with an embodiment, of the UE, base station and host computer discussed in the preceding paragraphs will now be described with reference to FIG. 13. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 13) served by base station 3320. Communication interface 3326 may be configured to facilitate connection 3360 to host computer 3310. Connection 3360 may be direct or it may pass through a core network (not shown in FIG. 13) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 13 may be similar or identical to host computer 3230, one of base stations 3212a, 3212b, 3212c and one of UEs 3291, 3292 of FIG. 12, respectively. This is to say, the inner workings of these entities may be as shown in FIG. 13 and independently, the surrounding network topology may be that of FIG. 12.

In FIG. 13, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310’s measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

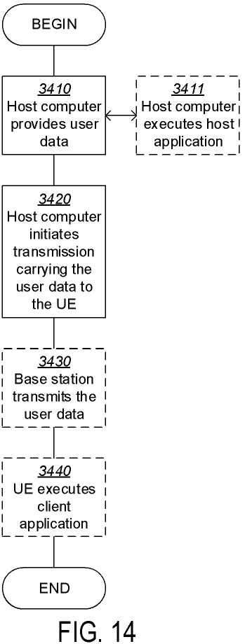

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

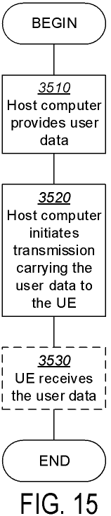

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

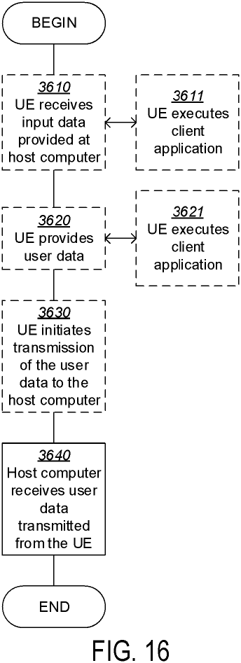

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

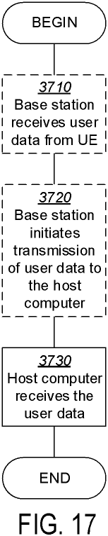

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method in a terminal device comprising:
determining a request message for random access, the request message comprising a preamble and one or more physical uplink shared channels (PUSCHs); and
transmitting the request message.

2. The method according to claim 1, wherein a fixed modulation and coding scheme (MCS) table is preconfigured to be used for determining the request message.

3. The method according to claim 1, wherein PI/2 binary phase shift keying(BPSK) is preconfigured to be disabled in the terminal device.

4. The method according to claim 1, wherein a number of the one or more PUSCHs is more than one, and the more than one PUSCHs are multiple repetitions of a PUSCH.

5. (canceled)

6. The method according to claim 4, wherein the random access is initiated due to a failure of a previous random access; and wherein a number of the multiple repetitions of the PUSCH for the random access is no less than that for the previous random access.

7. The method according to claim 4, wherein each repetition of the PUSCH is associated with the preamble.

8. The method according to claim 4, wherein a number of the multiple repetitions of the PUSCH is from at least one of:
radio resource control (RRC) signalling;
preconfiguration in the terminal device; and
determination based on at least one of: preamble information, demodulation reference signal (DMRS) information, use case information, and frequency band information.

9. The method according to claim 4, wherein the preamble and respective repetitions of the PUSCH are time division multiplexed, frequency division multiplexed, or both time division multiplexed and frequency division multiplexed.

10. The method according to claim 4, wherein each repetition of the PUSCH uses a corresponding redundant version (RV) in a RV sequence.

11. The method according to claim 10, wherein the RV sequence is from at least one of: radio resource control (RRC) signalling, and preconfiguration in the terminal device.

12. (canceled)

13. The method according to claim 1, wherein the request message is determined such that a size of a transport block (TB) carried in a PUSCH is scaled relative to a reference size of the TB carried in the PUSCH, with a scaling factor.

14. The method according to claim 13, wherein the reference size of the TB is determined based on a first product of: a number of resource elements (REs) usable for carrying the TB, a modulation order and a target code rate for the TB; and wherein the size of the TB is determined based on a second product of the scaling factor and the first product.

15. The method according to claim 13, wherein the scaling factor is from at least one of:
radio resource control (RRC) signalling;
preconfiguration in the terminal device;
selection from a preconfigured set of values based on a channel quality estimate; and
determination based on at least one of: preamble information, demodulation reference signal (DMRS) information, use case information, and frequency band information.

16. The method according to claim 1, wherein the request message is determined based on a modulation and coding scheme (MCS) table having a lower spectrum efficiency than a reference MCS table.

17. The method according to claim 16, wherein the MCS table is a table obtained by adding into, the reference MCS table, one or more rows having lower spectrum efficiencies.

18. The method according to claim 16, wherein the MCS table is obtained by removing, from the reference MCS table, one or more rows having higher spectrum efficiencies.

19-20. (canceled)

21. The method according to claim 1, wherein which MCS table is to be used for determining the request message is indicated via RRC signalling; or
wherein which a modulation and coding scheme (MCS) table is to be used for determining the request message is determined based on at least one of: preamble information, demodulation reference signal (DMRS) information, use case information, and frequency band information.

22. The method according to claim 1, wherein whether PI/2 binary phase shift keying (BPSK) is to be enabled for determining the request message is indicated via radio resource control (RRC) signalling; or
wherein PI/2 BPSK is preconfigured to be enabled in the terminal device.

23. A method in a base station comprising:
receiving a request message for random access, the request message comprising a preamble and one or more physical uplink shared channels (PUSCHs); and
obtaining the one or more PUSCHs from the request message.

24-44. (canceled)

45. A terminal device comprising:
at least one processor; and
at least one memory, the at least one memory containing instructions which, when executed executable by the at least one processor, cause the terminal device to:
determine a request message for random access, the request message comprising a preamble and one or more physical uplink shared channels (PUSCHs); and
transmit the request message.

46-51. (canceled)
